(19) United States
(12) Patent Application Publication
(10) Pub. No.: US 2023/0172800 A1
(43) Pub. Date: Jun. 8, 2023

(54) RESTORATION THERAPY HAND TOOL

(71) Applicant: David Hyun Jong Cho, Citrus Heights, CA (US)

(72) Inventor: David Hyun Jong Cho, Citrus Heights, CA (US)

(21) Appl. No.: 17/643,254

(22) Filed: Dec. 8, 2021

(51) Int. Cl. A61H 23/06; A61H 23/00

(52) U.S. Cl. CPC A61H 23/06; A61H 23/004; A61H 23/006; A61H 2201/0153; A61H 2201/169

(57) ABSTRACT

A manual restorative therapy tool is presented. A first tool includes a body, a first contact surface coupled to the first surface of the body, and second contact surfaces coupled to the second surface of the body, wherein each second contact surface of the array is smaller than the first contact surface. A handle may be coupled to a third surface that allows either the first or the second contact surface to be pressed against a user, expanding the user's blood vessels and lymphatic vessels. In this state, circulation may be further enhanced by use of a second tool having a handle with a first end and a second end, a first contact surface coupled to the first end via a compression mechanism, and a second contact surface coupled to the second end via a flexibility mechanism. The first and second contact surfaces independently spin with respect to the handle.

### TECHNICAL FIELD

The disclosure relates to a method and apparatus for restorative therapy.

### BACKGROUND

There are many aspects of modern day life and aging in general that compromise a person's sense of well-being and quality of life. For example, many jobs today require a person to sit in the same position for unnaturally long periods of time or engage in repetitive motion that causes muscle strain and discomfort. As people age, these “abuses” of our physical bodies may result in loss of muscle tone, muscle pain, joint pain, and stiffness. In extreme cases, the pain and stiffness result in an individual having to rely on wheelchairs and walkers to move around, limiting the types of activities the individual can engage in and taking away the individual's sense of independence and energy.

Restorative therapy improves one's mobility (walking, repositioning, standing up, sitting down, and transferring from one place to another). By allowing a person to move around more comfortably and independently, restorative therapy greatly improves the person's sense of well-being. There are restorative therapy services offered in forms of exercises, treatments, and massages. However, there seems to be a continuing need for improved methods and tools to bring people to the level of mobility and flexibility that they desire.

Different forms of “massages” have been used to apply pressure on different body parts, thereby reducing pain and improving one's mobility. While visits to chiropractors, massage therapists, and physical therapists may be helpful in reducing pain and improving one's mobility, new tools, methods, and equipment that cost-effectively and conveniently achieve this end are desired.

### SUMMARY OF THE DISCLOSURE

According to one aspect of the disclosure, a manual restoration therapy tool includes a body having a first surface and a second surface, a first contact surface coupled to the first surface, and a second contact surface coupled to the second surface. The second contact surface has at least one of a different size, a different shape, or a different surface texture than the first contact surface. One or both of the first contact surface and the second contact surface is coupled to the body by a spring mechanism.

According to another aspect of the disclosure, the body of the manual restoration therapy tool is a handle with a first contact surface at the first end and a second contact surface at the second end. The first contact surface and the second contact surface may be coupled to the body by different types of spring mechanisms.

### DESCRIPTION OF THE DRAWINGS

FIG. 1 depicts a restoration therapy tool of the disclosure being used on a user's back by another person.

FIG. 2 depicts the body of the restoration therapy tool 10 in accordance with an embodiment.

FIG. 3 depicts a cross sectional view of the restoration therapy tool in accordance with an embodiment.

FIG. 4 depicts the flexibility of the restoration therapy tool imparted by the spring mechanism between the handle and the body of the embodiment in FIG. 1.

FIG. 5A depicts a view of the restoration therapy tool showing a first contact surface, in accordance with an embodiment.

FIG. 5B depicts a view of the restoration therapy tool 10 showing the second contact surfaces, in accordance with an embodiment.

FIG. 6A depicts a restoration therapy tool in accordance with another embodiment.

FIG. 6B depicts the spring mechanisms inside the restoration therapy tool of FIG. 6A, in accordance with one embodiment.

FIG. 6C depicts a restoration therapy tool in accordance with another embodiment.

FIG. 7A depicts a top view of the restoration therapy tool of FIG. 6C being used on a body part, in accordance with an embodiment.

FIG. 7B depicts a side view of the restoration therapy tool of FIG. 6C being used on a body part, in accordance with an embodiment.

FIG. 7C depicts a top view of a restoration therapy tool being used on a body part, in accordance with an embodiment.

### DETAILED DESCRIPTION

The method and apparatus of this disclosure stem from the understanding that cells and nerves may be restored by a two-step process: 1) applying pressure on muscles and cells to cause expansion of blood vessel, nerves, and lymphatic vessels, and 2) helping the blood and lymph circulate through the expanded vessels. The manual restoration therapy tool of this disclosure may be used not only by those who have pain, discomfort, or mobility issues but also by healthy individuals for maintenance. The manual restoration therapy tool of this disclosure may be used on many body parts, including but not limited to one's back, neck, arms, legs, hands, and feet. As used herein, “manual” means a person (as opposed to a motor or a mechanical/electrical part) uses the tool.

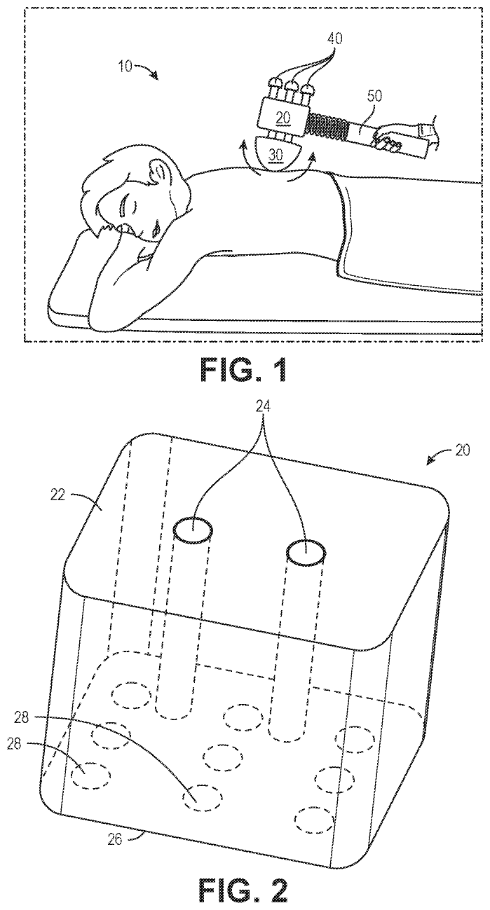

FIG. 1 depicts a restoration therapy tool 10 being used on a user's back by another person. Although the restoration therapy tool 10 may be used in various parts of the body, it may yield especially significant results when used on someone's back due to the importance of spine. As the spine supports a person's body and enables movements such as walking, twisting, etc., restoration of cells in and around the spine may significantly enhance the person's comfort and mobility.

As shown, the restoration therapy tool 10 has a body 20, a first contact surface 30 coupled to a first surface of the body 20, an array of second contact surfaces 40 coupled to a second surface of the body 20, and a handle 50 extending from a third surface of the body 20. In the particular embodiment shown, the first surface and the second surface of the body 20 are opposite surfaces of a body 20 that is shaped like a block, but this is not a limitation of the restoration therapy tool 10 disclosed herein. A “contact surface,” as used herein, is intended to mean the surface that may contact the user during application.

FIG. 2 depicts the body 20 of the restoration therapy tool 10 in accordance with an embodiment. In this embodiment, the body 20 has a block or a generally cube-like shape with six large surfaces. The particular embodiment shows a first surface 22 with access to first cavities 24 that extend into the body of the body 20. There is also a second surface 26 that is, in this embodiment, on the opposite side of the body 20. The second surface 26 has access to second cavities 28 that extend into the body of the body 20. Neither the first cavities 24 nor the second cavities 28 are through-holes; neither of them extends through the entire thickness of the body 20 to open on the opposite surface. The dimensions of the first cavities 24 may be different from or the same as the dimensions of the second cavities 28.

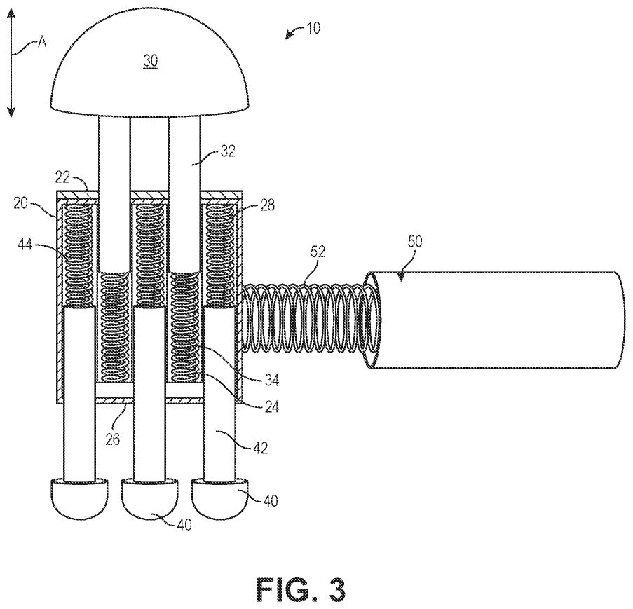

FIG. 3 depicts a cross sectional view of the restoration therapy tool 10 in accordance with an embodiment. This cross sectional view shows that the first contact surface 30 has one or more stems 32 that extend into the first cavities 24. There is a spring mechanism 34 inside the cavity 24 between the stem 32 and the end wall of the cavity 24. The spring mechanism 34 allows the first contact surface 30 to move up and down as shown by an arrow A when pressure is applied to the first contact surface 30, such as when the first contact surface 30 is pushed against a user's body. As a result of the compression, the user would get a comforting pressure instead of a painful “blow.” The spring mechanism 34 is not limited to actually being a spring, and any type of mechanism or material that provides shock absorbance or compressibility may be used.

The second contact surfaces 40 are connected to one or more stems 42 that extend into the second cavities 28. Similarly to the first cavities 24, there is a spring mechanism 44 inside each second cavity 28 to soften the pressure of the second contact surfaces 40 against a person's body. The first and second contact surface of the embodiment have a “dome” shape that may look like half of a sphere from the side.

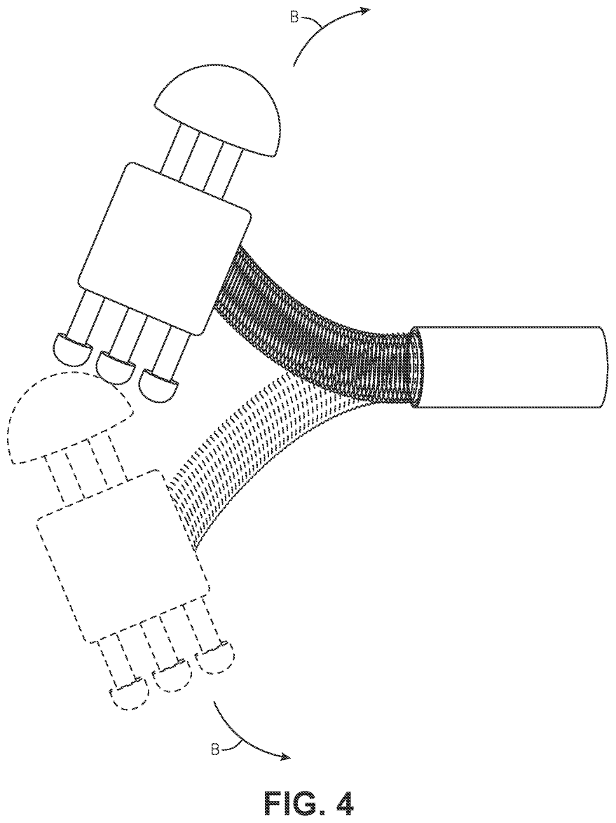

The handle 50 may be attached to the body 20 via a spring mechanism 52. As depicted in FIG. 4, the spring mechanism 52 is bendable, allowing the body 20 to move in the direction of the arrows B. The spring mechanism 52 further softens the pressure when the first contact surface 30 or the second contact surfaces 40 come in contact with a user's body. The spring mechanism 52, the spring mechanism 34, and the spring mechanism 44 together prevent the restoration therapy tool 10 from “hurting” a user, by building in a certain amount of “give.” A user should not feel like a hard hammer is being pushed onto his or her body part. With the “give” that is offered by the spring mechanisms 52, 34, and 44, pressure may be delivered to a user in a gentle, controlled manner without pain.

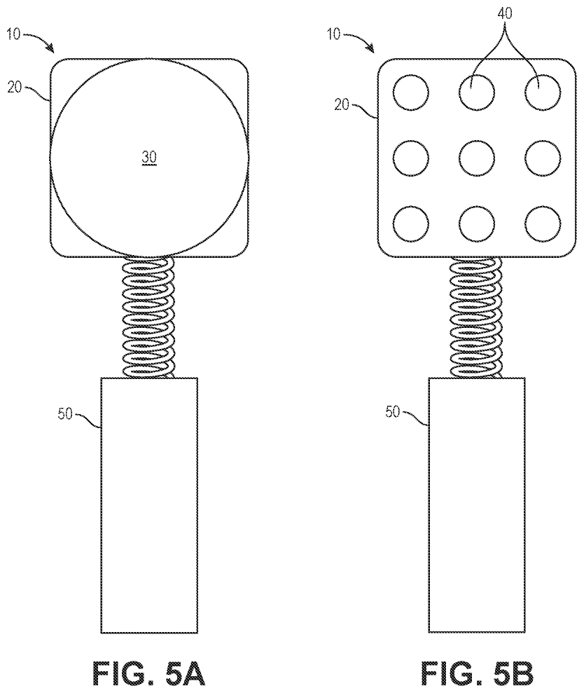

FIG. 5A depicts a view of the restoration therapy tool 10 showing the first surface with the first contact surface 30, in accordance with an embodiment. In this embodiment, only one first contact surface 30 is present because the first contact surface 30 is sized so that only one can fit on the first surface 22. However, this is not a limitation of the inventive concept. In FIG. 5B, the second contact surfaces 40 are arranged in a 3×3 matrix on the second surface 26. In the particular embodiment that is shown, the second contact surfaces 40 are not all of the same size; rather, some of them are the same size and others are not. Where the contact surfaces are dome-shaped, they may have different diameters. The inventive concept is not limited to the second contact surfaces 40 all being of the same size or of different sizes. There are also many different ways the second contact surfaces 40 may be arranged. For example, they do not have to be arranged in a matrix configuration. They may be arranged to form a circular pattern or any other pattern.

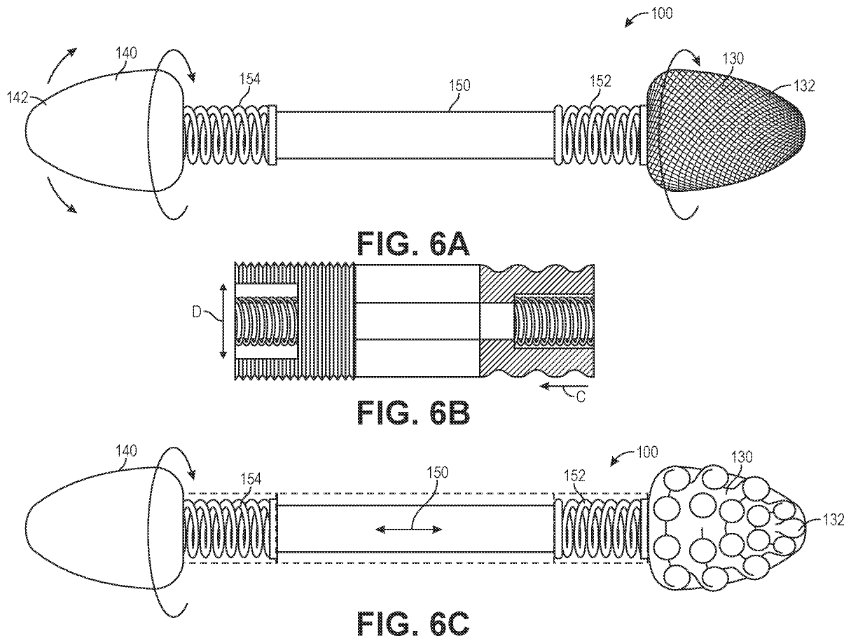

FIG. 6A depicts a restoration therapy tool 100 in accordance with another embodiment. In this embodiment, the body 150 is a rod-shaped handle with a first end and a second end. A first contact surface 130 is coupled to a first surface at the first end via a first spring mechanism 152. A second contact surface 140 is coupled to a second surface at the second end via a second spring mechanism 154. The first and second ends of the body 150 are opposite ends of the handle 150. The first contact surface 130 may have a textured or “bumpy” surface. The second contact surface 140 may be smooth or have a texture that is different from the first contact surface 130, and may be of a different size and/or shape from the first contact surface 130. In the particular embodiment shown, the first contact surface 130 and the second contact surface 140 have a bulb-like shape that has a rounded, blunt tip 132, 142 at the farthest end from the handle 150. However, this is not a limitation of the concept and the shapes of the first and second contact surfaces 130, 140 may be varied.

The first spring mechanism 152 is a compressible mechanism that allows the first contact surface 130 to be pushed closer toward the handle 150 in the direction C shown in FIG. 6B, in response to pressure. The second spring mechanism 154 that couples the second contact surface 140 to the handle 150 is a flexibility mechanism that is configured to bend, allowing the second contact surface 140 to move primarily in the direction D shown by the arrows in FIG. 6B, in response to pressure. Depending on the embodiment, the first spring mechanism 152 and the second spring mechanism 154 may be both compressible and flexible.

The first contact surface 130 is attached to the first spring mechanism 152 in a manner that allows it to spin relative to the handle 150, as shown by the circular arrow of FIG. 6A. In some embodiments, the first spring mechanism 152 may rotate or spin relative to the handle 150 with the first contact surface 130. In other embodiments, the first spring mechanism 152 may stay “fixed” with relative to the handle 150 and just the first contact surface 130 spins. Similarly, the second contact surface 140 may spin relative to the second spring mechanism 154 and the handle 150, or the second spring mechanism 154 may remain “fixed” relative to the handle 150 and just have the second contact surface 140 spin.

FIG. 6C depicts another embodiment of the restoration therapy tool 100. The pattern/texture of the first contact surface 130 in this embodiment is different from the pattern/texture of the first contact surface 130 in the embodiment of FIG. 6A. The exact texture of the first contact surface 130 is not limited to what is depicted in the figures, and may be adapted so that optimal pressure is applied to a body part during use.

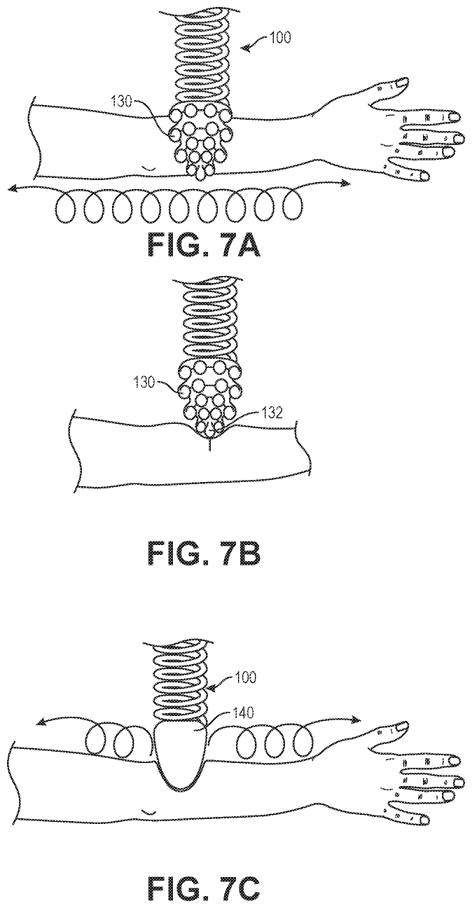

FIG. 7A depicts a top view of the restoration therapy tool 100 being used on a user, in accordance with an embodiment. Specifically, FIG. 7A depicts the restoration therapy tool 100 being used on a person's arm; however, this is just an example and the tool 100 may be used on other parts of a person's body such as back and legs. In the particular example that is depicted in FIG. 7A, the first contact surface 130 may be laid on a user's arm and moved along the length of the arm while applying pressure, such that the first contact surface 130 rolls on the user's skin. The bumps on the pattern of the first contact surface 130 push into the arm, helping and inducing circulation. FIG. 7B depicts a side view of the restoration therapy tool 100 being rolled on a user's arm, in accordance with an embodiment. The pattern of the first contact surface 130 is pressed into the arm, as shown by the surface of the arm being pushed in.

FIG. 7C depicts a top view of the second contact surface 140 being used on a person's body, e.g. an arm. Similarly to FIG. 7A, the second contact surface 140 is rolled along the length of the arm. The deep pressure helps the blood and lymph circulate through the vessels.

The restoration therapy tool 10, when applied properly, helps break down the muscle and cell of a user, allowing the blood vessels, nerves, and lymphatic vessels to expand. The restoration therapy tool 100, when used after the vessels are expanded using the restoration therapy tool 10, helps blood and lymph circulation through the expanded vessels. Hence, using the two restoration therapy tools 10, 100 together effectively achieves muscle and cell restoration and improvement of blood and lymphatic circulation.

In the preceding specification, the inventive concept has been described with reference to specific exemplary embodiments. It will, however, be evident that various modifications and changes may be made without departing from the broader spirit and scope of the inventive concept as set forth in the claims that follow. The specification and drawings are accordingly to be regarded as illustrative rather than restrictive. Other embodiments of the disclosure may be apparent to those skilled in the art from consideration of the specification and practice of the concept disclosed herein.

What is claimed is:

1. A manual therapy tool comprising:
a body having a first surface and a second surface;
a first contact surface coupled to the first surface;
a second contact surface coupled to the second surface, wherein the second contact surface has at least one of a different size, different shape, or different surface texture than the first contact surface.

2. The manual therapy tool of claim 1, wherein the first surface and the second surface are on opposite ends of the body.

3. The manual therapy tool of claim 1, wherein at least one of the first contact surface and the second contact surface is coupled to the body by a spring mechanism.

4. The manual therapy tool of claim 1, wherein the second contact surface is one of an array of second contact surfaces coupled to the second surface.

5. The manual therapy tool of claim 4, wherein the second contact surfaces of the array have varying sizes or diameters.

6. The manual therapy tool of claim 1, wherein the first contact surface is connected to a stem extending into a first cavity accessible from the first surface of the body to contact a spring mechanism inside the cavity.

7. The manual therapy tool of claim 6, wherein the first contact surface has one or more stems extending into different cavities in the body, each of the cavities containing a spring mechanism.

8. The manual therapy tool of claim 4, wherein each of the second contact surfaces in the array is connected to a stem extending into a second cavity that is accessible from the second surface of the body to contact a spring mechanism.

9. The manual therapy tool of claim 4, wherein the second contact surfaces in the array are arranged in a matrix configuration.

10. The manual therapy tool of claim 9, wherein the second contact surfaces are arranged in a 3×3 matrix configuration.

11. The manual therapy tool of claim 1, wherein the body has a first set of cavities accessible from the first surface and a second set of cavities accessible from the second surface, the first contact surface is connected to one or more stems that extend into the first set of cavities containing the spring mechanism, and the second contact surfaces are connected to one or more stems that extend into the second set of cavities that contain spring mechanisms.

12. The manual therapy tool of claim 10, wherein the first set of cavities have different dimensions from the second set of cavities.

13. The manual therapy tool of claim 1 further comprising a handle coupled to a third surface of the body.

14. The manual therapy tool of claim 13, wherein the handle is attached to the body by a spring mechanism.

15. The manual therapy tool of claim 1, wherein the body is a handle with the first surface at a first end and the second surface at a second end of the handle.

16. The manual restoration therapy tool of claim 15, wherein the spring mechanism coupling the first contact surface to the first surface is different from the spring mechanism coupling the second contact surface to the second surface.

17. The manual restoration therapy tool of claim 15, wherein the spring mechanism coupling the first contact surface to the first surface is a compression mechanism that brings the first contact surface closer to the body in response to pressure.

18. The manual restoration therapy tool of claim 15, wherein the spring mechanism coupling the second contact surface to the second surface is a flexibility mechanism that bends in response to pressure.

19. The manual restoration therapy tool of claim 15, wherein at least one of the first contact surface and the second contact surface independently spins with respect to the body.

20. The manual therapy tool of claim 15, wherein at least one of the first contact surface and the second contact surface has a round, blunt tip.
